(19) United States
(12) Patent Application Publication
(10) Pub. No.: US 2007/0077843 A1
(43) Pub. Date: Apr. 5, 2007

(54) FABRIC FOR COVERINGS FOR ARCHITECTURAL OPENINGS AND METHOD AND APPARATUS FOR MANUFACTURING SAME

(76) Inventors: Gregory P. Harkenrider, Thornton, CO (US); Shannon D. Dunn, Boulder, CO (US); Nancy G. Williams, Boulder, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/535,665

(22) Filed: Sep. 27, 2006

Related U.S. Application Data
(60) Provisional application No. 60/723,171, filed on Oct. 3, 2005.

(51) Int. Cl. B32B 5/26; D04H 3/05; B32B 27/02

(52) U.S. Cl. 442/366; 442/389; 442/392

(57) ABSTRACT

A fabric for a covering for architectural openings is comprised of a laminate having at least one layer of yarns having at least two different yarn materials that are deployed in parallel closely adjacent or contiguous relationship and integrated with a coating of adhesive. One or more layers of a nonwoven fabric are bonded to one or both surfaces of the yarn layer so that the laminate fabric has two or more layers including a layer of parallel yarns. The yarns can be made of different materials as well as different sizes and weights to vary the characteristics of the fabric.

### CROSS-REFERENCE TO RELATED APPLICATION

The present application claims the benefit under 35 U.S.C. § 119(e) to U.S. Provisional Patent Application No. 60/723,171 (“the '171 application”), which was filed on Oct. 3, 2005 and entitled “Fabric For Coverings For Architectural Openings and Method and Apparatus For Manufacturing Same.” The '171 application is incorporated by reference into the present application in its entirety.

### BACKGROUND OF THE INVENTION

1. Field of the Invention

The present invention relates generally to coverings for architectural openings and more particularly to a fabric for such a covering and a method and apparatus for manufacturing the fabric.

2. Description of the Relevant Art Coverings for architectural openings have assumed numerous forms for many years. Early forms of such coverings were simply fabrics draped or otherwise suspended across an architectural opening such as a window, door, archway or the like. More recently, retractable coverings have been popular with some such coverings simply being a retractable roller shade wherein a sheet of flexible fabric or synthetic material is wrapped around a roller in a retracted position of the covering and extended from the roller across the opening in an extended position.

Designer coverings have become popular and are made of aesthetically attractive materials and formed into attractive configurations with many such coverings being cellular for both aesthetic and insulative reasons. Some such shades are made with sheer fabrics and others from opaque or translucent fabrics with the materials possibly being folded and/or creased to assume desired cellular configurations. It is important the fabric being used provides desired characteristics from both a visual and tactical standpoint and can further be easily folded and/or creased.

It is to provide a new and improved fabric for coverings for architectural openings that the present invention has been developed.

### SUMMARY OF THE INVENTION

The fabric of the present invention is primarily designed for use in a covering for an architectural opening so as to have desired aesthetics as well as tactile qualities. The fabric can be easily folded in one direction and resist folding in an orthogonal direction as desired for some covering products. The fabric is a laminate having one layer of aligned parallel side-by-side yarns of at least two different materials which may be naturally occurring or synthetics with the yarns being adhesively secured together. Another layer is a nonwoven also having an adhesive layer so that the nonwoven layer along with the yarn layer can be laminated together in a compressive heat process. A third layer of a nonwoven having an adhesive coating can also be laminated to the opposite side of the yarn layer, if desired.

The resultant laminate fabric can have a soft feel due to the use of naturally occurring fibers and a strength from the use of synthetic fibers and is also readily foldable along the length of the yarns of the yarn layer while being more difficult to fold transversely of the yarns.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric of a panel of covering material for an architectural opening made from the fabric of the present invention.

FIG. 2 is a fragmentary isometric of a strip of fabric material made in accordance with the present invention.

FIG. 3 is an enlarged section taken along line 3-3 of FIG. 2.

FIG. 4 is a further enlarged section of that shown in FIG. 3.

FIG. 5 is an exploded section showing the three layers of the laminate fabric of the present invention.

FIG. 6 is an isometric of a laminating apparatus for laminating the layers of the fabric of the present invention.

FIG. 7 is an enlarged fragmentary section illustrating a portion of the apparatus of FIG. 6 where the layers of the fabric are fed between compressive belts.

FIG. 8 is a diagrammatic side elevation of an apparatus for fabricating the yarn layer of the fabric of the present invention.

FIG. 9 is a fragmentary diagrammatic top plan view of the upstream end of the apparatus of FIG. 8.

FIG. 10 is a diagrammatic isometric of an apparatus for gathering yarns from a plurality of spools and wrapping them on a supply beam of yarn.

### DESCRIPTION OF THE PREFERRED EMBODIMENTS

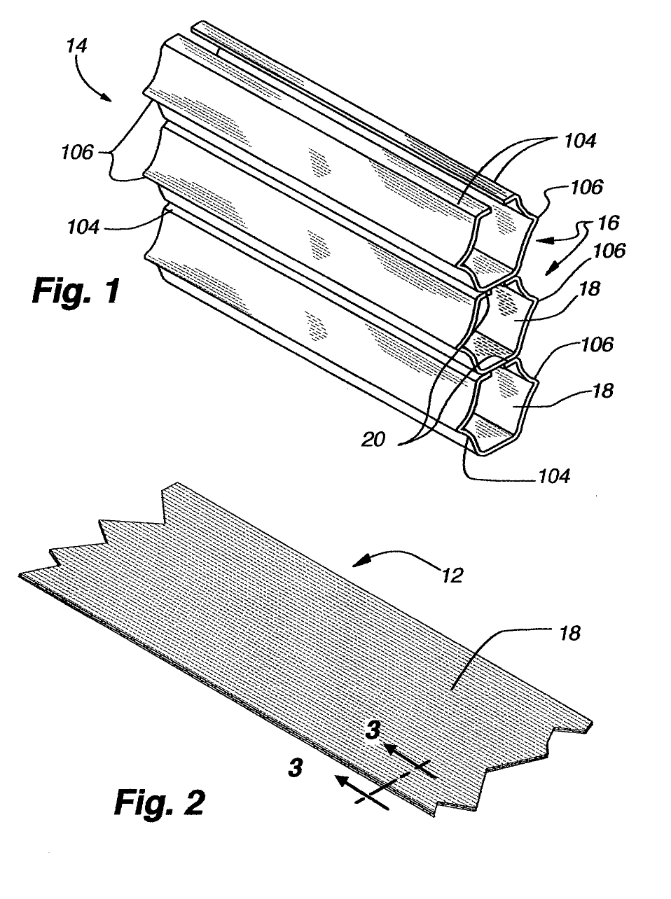

The fabric 12 of the present invention finds use in numerous covering products for architectural openings with an example of a panel 14 for use in such a product being shown in FIG. 1. The panel 14 shown in FIG. 1 is a cellular panel described in detail in U.S. Pat. Re-Exam No. 4,603,072, entitled Honeycomb Insulating Material, which is of common ownership with the present application. The panel includes a plurality of elongated cells 16 that would typically be suspended horizontally in an architectural opening such as a window, door, archway, or the like. Each cell is made from a strip 18 of material that has been creased and folded into a generally hexagonal transverse configuration even though other configurations of cellular panels of the general type are also possible. Each strip after being creased and folded is adhesively or otherwise secured at 20 to an adjacent folded strip until the panel of the cells has been assembled of the desired size and configuration. When a covering including such a cellular panel is extended across an architectural opening, the cells are expanded as shown in FIG. 1 whereas when the covering is retracted the cells are transversely collapsed and neatly stacked adjacent a top, bottom, or side of the opening depending upon the orientation of the cells and the desired direction of extension and retraction.

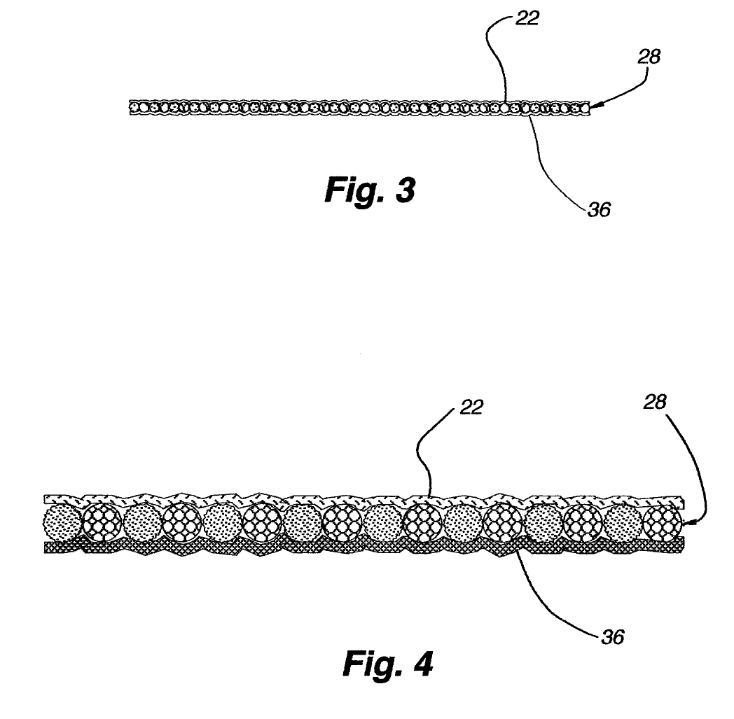

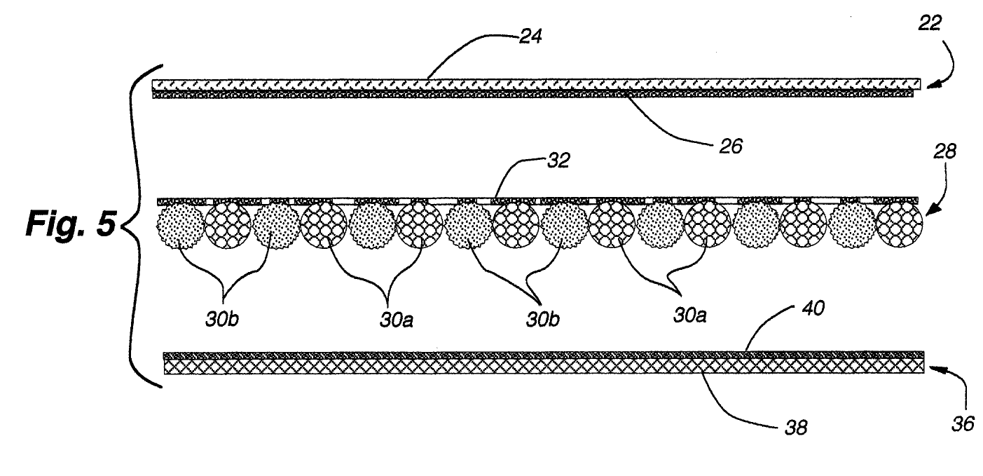

The fabric 12 of the present invention, as shown best in FIGS. 2-5, is a laminate which may have two or three layers as will be described in detail hereafter. At least one outer layer 22 is preferably a nonwoven base fabric 24 with an adhesive coating 26 and wherein the nonwoven fabric is generally characterized as being a sheet of manufactured batting or webbing of fabric that is held together by thermo-fusion, resin or solvent bonding to provide an interlocking of fibers. A preferred nonwoven product is one manufactured by Unitika of Kyoto, Japan, and sold under Style No. 20257/WTD. This product is a sheet of randomly oriented fibers of a synthetic material that are interlocked mechanically and with resin. The nonwoven base fabric 24 is coated with a hot-melt adhesive that could be applied as a liquid at a temperature above its melting point and allowed to set by cooling on the nonwoven fabric for ease in later handling. A preferred adhesive is a copolyester adhesive manufactured by EMS Griltex of Middleton, Mass., under Style 1533. The adhesive can be applied at any desired weight but preferably 6-8 grams per square meter (gpsm).

A second layer 28 of the fabric 12 is made from a plurality of parallel elongated yarns 30a and 30b which are positioned in closely adjacent or contiguous side-by-side relationship and bonded together with an adhesive coating 32 on one side of the parallel yarns. There are preferably yarns of at least two different types in the layer of yarns with the yarns 30a of one material desirably being spaced by yarns 30b of another material. Of course if there are more than two different types of yarns they are preferably alternated in a plurality of series as best as possible. As will be appreciated from the above and the description that follows, while it is desirable that the yarns 30a be alternated with other types of yarns 30b in the yarn layer, if the alternation is not perfect, it does not totally distract from the desirability of the yarn layer for purposes of the fabric of the present invention. The yarns could include mono and multi-filament yarns and strands of material. Further, the yarns could be large or small in diameter or denier and can be made from many types of material including but not limited to polyester, polyethylene, polypropylene, and other polymers or plastics; wool, cotton, hemp, flax, and other natural fibers; blends of natural and/or synthetic fibers; glass, metal, graphite and the like. It is even conceivable the yarns could be copper or aluminum wire. It should also be appreciated with the description that follows that various densities of yarns are possible with these densities varying depending upon the type of yarn used, the spacing of those yarns and the desired characteristics of the fabric being manufactured. It is important that at least one of the yarns be a material that adheres to the adhesive used to laminate the yarn layer to the nonwoven layer(s). This adhesion provides for the adhesion of all the other yarns and thus the integrity of the laminated fabric.

A preferred fabric is made with two different types of yarns with one of the yarns being a polymer and the other yarn of a naturally occurring material. By way of example, a polyester yarn 30a could be used with a cotton yarn 30b to obtain a desirable yarn layer 28 for the fabric product 12. In such an instance, it is preferable to alternate the polyester yarns with the cotton yarns as probably seen best in FIG. 5 even though a precise alternating pattern is not critical to the yarn layer of the fabric. After the yarns have been assembled into an elongated parallel side-by-side relationship where the yarns are either contiguous or closely spaced with adjacent yarns, they are coated with the adhesive 32 to retain the yarns in their parallel predetermined relationship.

The density of the yarns, meaning the number of yarns per inch of the fabric width, i.e. the cross-direction of the yarn length, will have a direct bearing on the opacity of the fabric as does the particular material from which the yarns are made. In the preferred fabric 12 having cotton 30b and polyester 30a yarns, there are 72 such yarns per inch of fabric width and the yarns are 30/1's or 180 denier. Preferably both the polyester and cotton yarns are ring spun. The yarns can of course also be processed with a dye so the yarns are any desired color.

It will also be appreciated by using yarns of a larger denier, the fabric will have a more coarse appearance while yarns of smaller denier will give a finer appearance. The yarns can also be made of varying weights.

The adhesive 32 used to coat the yarns 30a and 30b is preferably a hot-melt adhesive, which can be applied in liquid form while preheated above the melting temperature of the adhesive, but will quickly set or dry when cooled for convenient handling and processing of the yarn layer. The adhesive is also preferably of the type that can be reheated to obtain a tacky state for adherence to other layers of the fabric product 12. An adhesive which has been found desirable for the yarn layer 28 of the present invention is a copolyester glue that is applied to the yarns at a weight of 18 to 20 gpsm. The preferred adhesive is the same adhesive used on the aforedescribed nonwoven layer 22.

In accordance with the present invention, the fabric 12 can be made by adhesively bonding the afore-described nonwoven layer 22 with the yarn layer 28 in a manner to be described hereafter but the fabric could also include a third layer 36 preferably of a nonwoven material 38 which is bonded to the opposite side of the yarn layer 28 from the first-described nonwoven layer 22. The second nonwoven material 38 would be generally characterized as the nonwoven in the first layer with a preferred nonwoven material being one manufactured by Hollingsworth and Vose of Floyd, Virginia, under Style TR102001. This nonwoven is a solvent pinpoint smooth calendared roll tape. The nonwoven is then coated with an adhesive 40 that again would be a hot-melt adhesive so that it could be applied at a temperature above its melting temperature and would set quickly when cooled or when exposed to room temperature. An example of a desired adhesive would be a 50/50 blend of adhesives manufactured by EMS Griltex under Style Nos. 9P and 1377. The adhesive coating 40 could be applied at any desirable weight but would preferably be applied at 6-8 gpsm. The third layer may provide protection to any natural yarns used in the yarn layer by blocking ultraviolet light and may also enhance yarn tie down in the yarn layer.

In manufacturing a fabric 12 having the above characterized layers, the nonwoven layers 22 and 36 can be manufactured according to known processes or simply purchased from known sources. The products may be precoated with the identified adhesives and if not, the adhesives can be coated on the nonwoven in accordance with known processes.

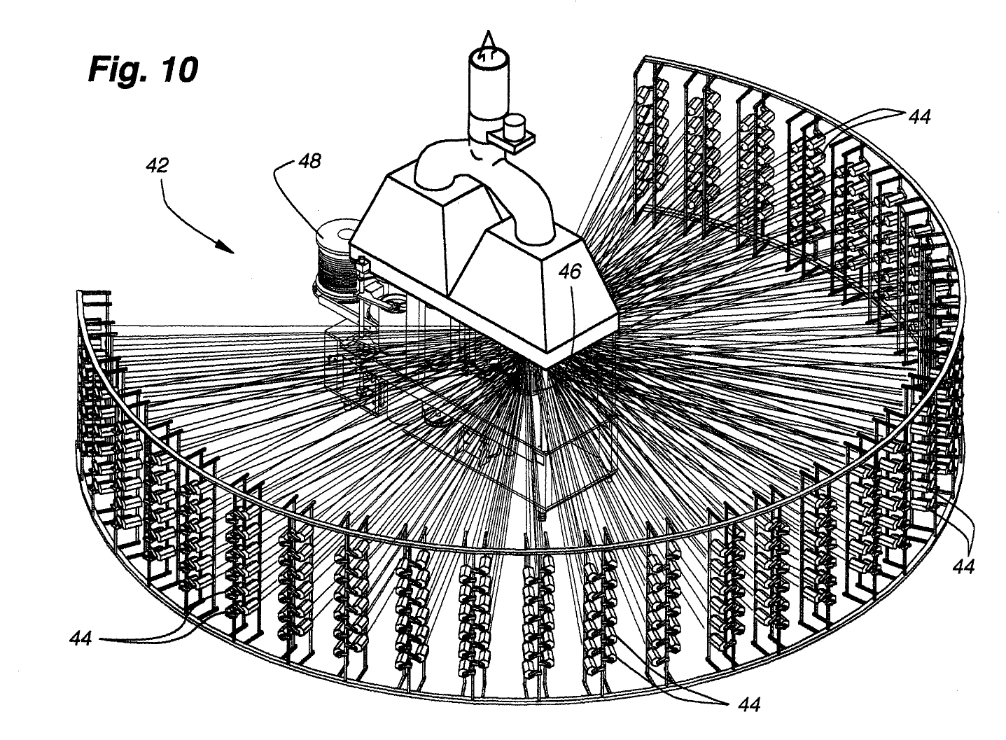

The yarn layer 28, as mentioned, is preferably made from at least two different yarns 30a and 30b. Such yarns are typically supplied on spools. In order to form the yarn layer of the fabric of the present invention, the yarn on the spools must be transferred to beams with the yarns wrapped around the beams in an orderly fashion so they can be removed from the beam merely by pulling the yarn from the beam and allowing the beam to yieldingly rotate as yarn is being removed therefrom. An apparatus 42 for removing yarn from spools thereof and wrapping them on a beam in an orderly fashion is disclosed in U.S. Pat. No. 7,017,244 entitled Beam Winding Apparatus, which is of common ownership with the present application and the disclosure of which is hereby incorporated by reference. In that machine, which is diagrammatically illustrated in FIG. 10, spools 44 of the designated yarn, e.g. 30a, are spaced around a comb 46 so that yarn 30a is fed from the spools to the comb and emanates from the comb. The yarns emanating from the comb are wrapped around and collected on a beam 48. The beams can be removed from the apparatus and placed in a fabricating apparatus 50 to be described hereafter where the yarns are assembled in side-by-side relationship into a common layer with other yarns supplied on similar beams. In the fabricating apparatus 50 as will be explained hereafter, the yarns are preferably assembled in closely adjacent or contiguous side-by-side relationship and preferably in an alternating pattern with yarns of different materials.

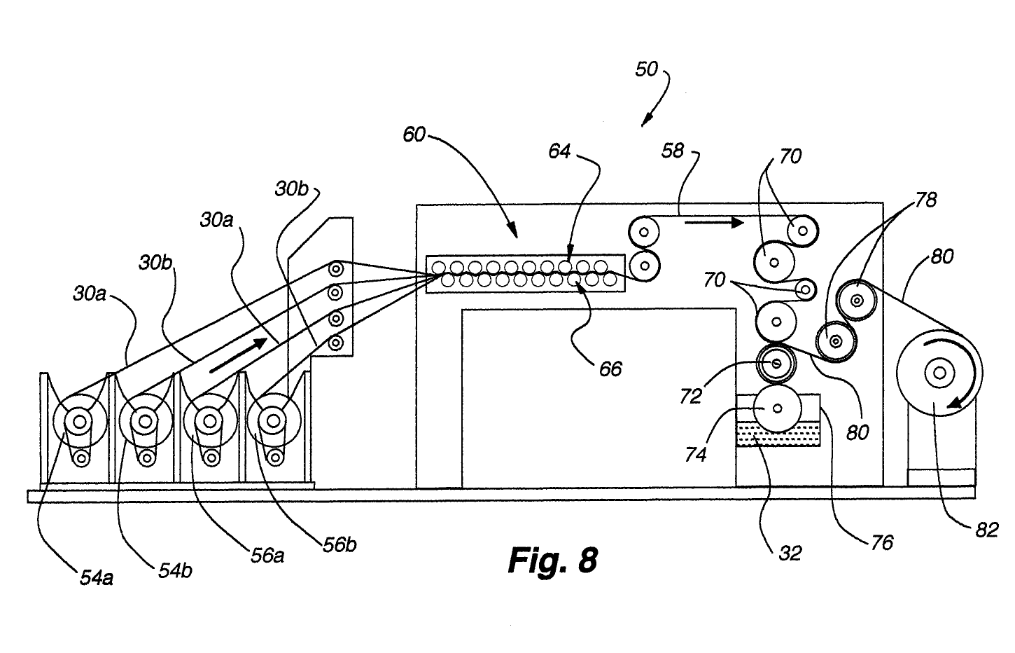

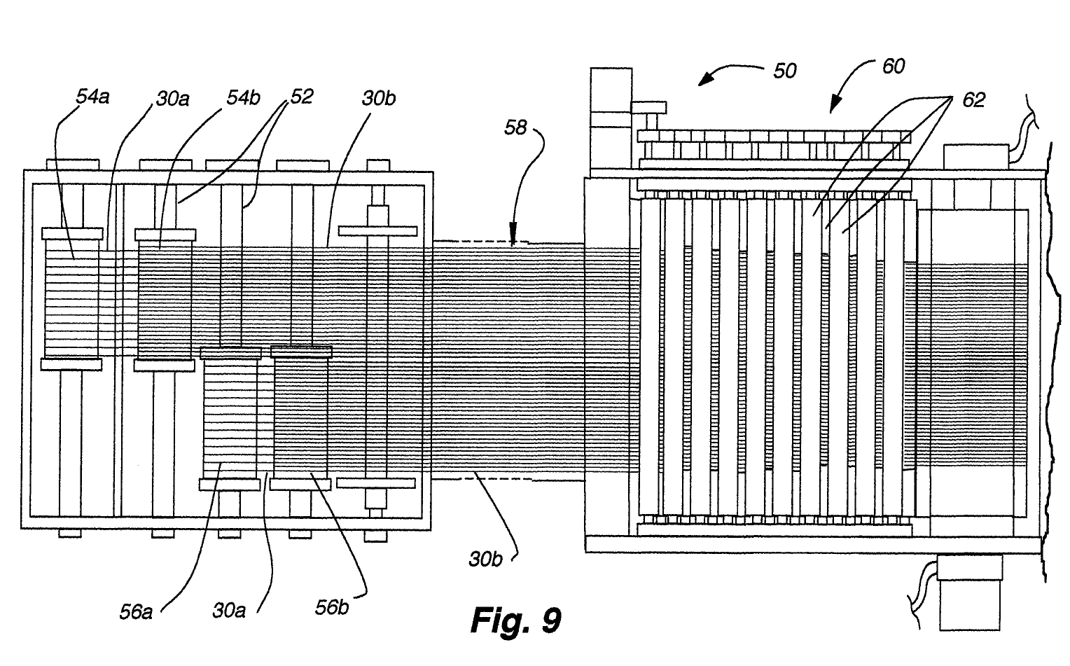

The fabricating apparatus 50 is shown diagrammatically in FIGS. 8-9. In that apparatus, it will be seen at the upstream end of the apparatus, illustrated on the left of the figures, that supports 52 are provided for a plurality of beams of yarns. As best seen in FIG. 9, there are four beams of yarns with two beams 54a and 56a being of one yarn 30a, for example a polyester yarn, and the other two beams 54b and 56b of a second yarn 30b, for example a cotton yarn. A first beam 54a of polyester yarn 30a and a first beam 54b of cotton yarn 30b are transversely disposed in spaced machine directional alignment while an identical second beam 56a of polyester yarn 30a and a second beam 56b of cotton yarn 30b are transversely disposed in spaced machine direction alignment and downstream from the first beams. The second beams 56a and 56b are offset laterally from the first beams 54a and 54b so the yarns being fed off each beam in a downstream direction are in adjacent side-by-side relationship. As will be appreciated, on one side of the fabrication apparatus, the first beam 54a of polyester yarn and the first beam 54b of cotton yarn will supply yarns for one half of a panel 58 of all of the yarns while the second beam 56a of polyester yarn and the second beam 56b of cotton yarn will supply yarns for an adjacent half of the panel 58 of all the yarns. It will also be appreciated the cotton yarns 30b coming off each cotton yarn beam are fed in an intermingling manner with the polyester yarns 30a coming off each polyester yarn beam so that the yarns in the resultant panel of yarns are alternating between polyester and cotton. The polyester 30a and cotton yarns 30b are alternately distributed across the entire width of the panel 58 of yarns as seen in FIG. 9. A fabricating apparatus of the type illustrated in FIGS. 8 and 9 is described in more detail in PCT Application WO 01/21877 A1 entitled Non-Woven Warp Yarn Fabric Materials and Method and Apparatus for Manufacturing Same, which is of common ownership with the present application and the disclosure of which is hereby incorporated by reference.

It will be appreciated the panel 58 of disconnected yarns formed as described above is fed downstream through an alignment station 60 where the yarns pass over and under sets of rollers 62 with the rollers being organized in an upper set 64 of transversely extending rollers that are spaced in the machine direction and a lower set 66 of transversely extending rollers that are spaced in the machine direction. The rollers in the upper set are offset in the machine direction from the rollers in the lower set.

The panel 58 of disconnected but aligned yarns emanating from the beams is fed through the rollers 62 so as to pass over the top of the lower set 66 of rollers and beneath the bottom of the upper set 64 of rollers in a sinuous path. The rollers have a textured coating (not seen) of granular material, such as sandpaper, with the more upstream rollers having a coarser coating than the more downstream rollers. The density of the texture on the rollers decreases substantially uniformly from the upstream end to the downstream end. The coarse coating on the upstream rollers serves to macro organize and align the plurality of yarns in the panel of yarn with the downstream rollers having the finer coating serving to micro organize. When the panel 58 leaves the alignment station 60, the intermingled yarns 30a and 30b are uniformly aligned in closely adjacent or contiguous relationship and in the flat panel of disconnected yarns.

The panel 58 of disconnected yarns then travels downstream into an adhesive application unit 68 where a layer or coating of the adhesive 32 is applied to one surface of the yarns 30a and 30b to bond the yarns into an integrated panel. The yarns are drawn around a plurality of idler rollers 70 that ultimately direct the panel 58 of disconnected yarns across the top surface of an adhesive transfer roller 72 whose bottom surface is engaged with an adhesive pick-up roller 74 that is partially submerged in a bath 76 of the hot-melt adhesive 132. The hot-melt adhesive is thereby picked up by the pick-up roller, transferred to the transfer roller, and from the transfer roller to the adjacent bottom surface of the disconnected yarn panel 58 with the adhesively coated yarns then passing over a pair of idler cooling rollers 78 to quickly set the adhesive so it is no longer tacky. The integrated and adhesively bonded yarn panel 80 is accumulated on a driven take-up roller 82, which has pulled the yarns through the fabrication apparatus. It will be appreciated the integrated yarn panel 80 in cross-section would be as illustrated in FIG. 5 with the adjacent side-by-side yarns 30a and 30b having a coating of the adhesive 32 on one surface thereof.

If either of the nonwoven layers of material 22 or 36 was not supplied with an adhesive coating on one surface thereof, the nonwoven base material could be processed through the fabrication apparatus 50 shown in FIGS. 8 and 9 with the nonwoven base material replacing the yarns so that a layer of adhesive could be applied to the nonwoven base material in the same manner as adhesive was applied to the yarns. Regardless of how the adhesive coating is applied to the nonwoven base material, however, before integration or lamination into the fabric of the present invention, each layer of the fabric would preferably have an adhesive coating to facilitate bonding of the layers.

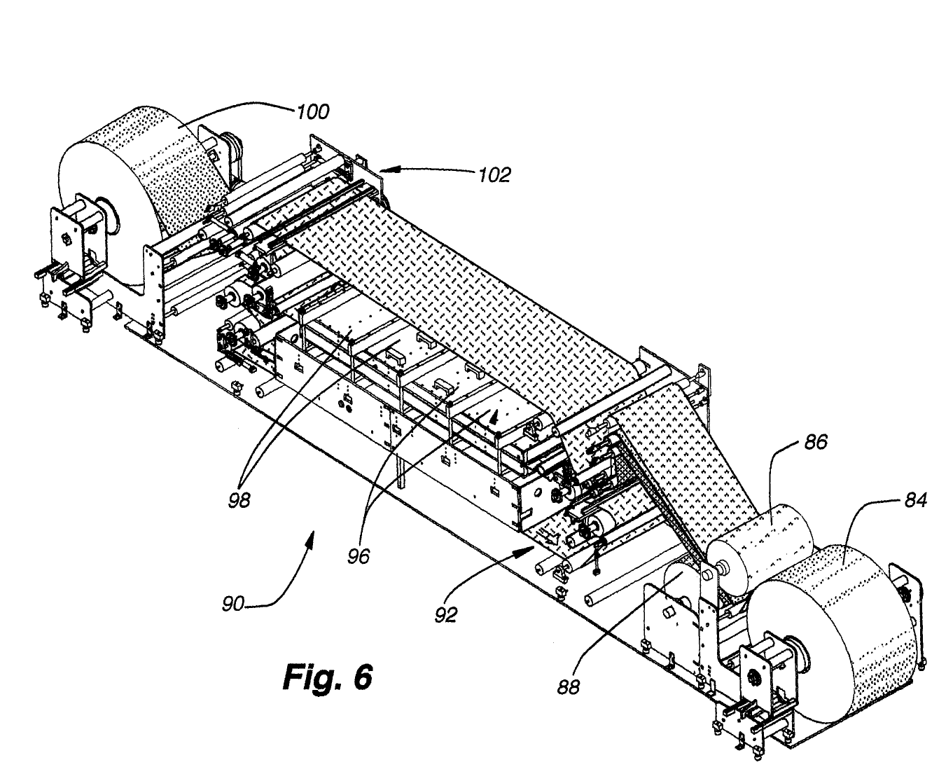

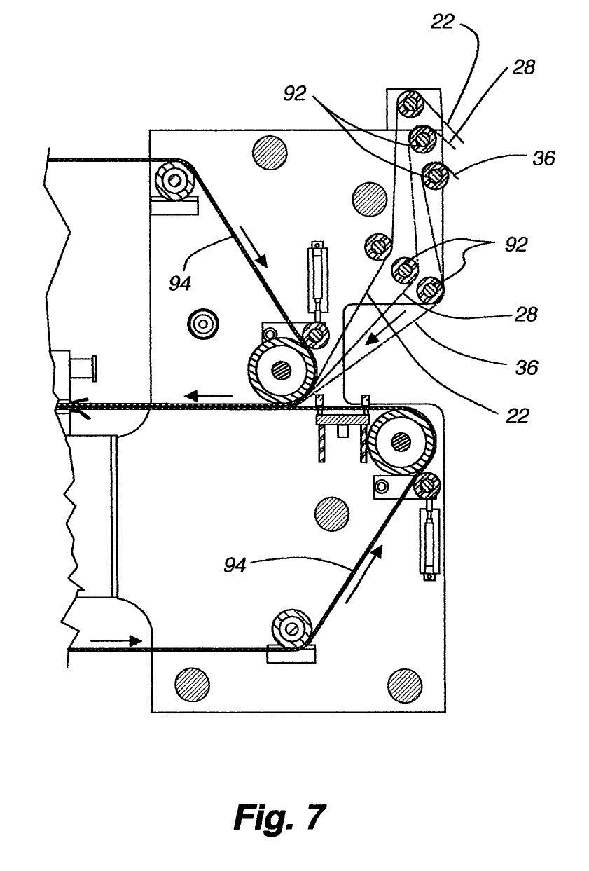

To laminate the yarn layer 28 with either or both of the nonwoven layers 22 and/or 36, they are fed as a continuous sheet in overlying relationship to each other from supply rolls 84, 86 and 88 into a laminator 90 (FIGS. 6 and 7). An example of a laminator suitable for this purpose is described in U.S. Pat. No. 7,090,743 entitled Pressure Laminator Apparatus, which is of common ownership with the present application and the disclosure of which is hereby incorporated by reference. Such a laminator is diagrammatically illustrated in FIGS. 6 and 7 with the apparatus shown in entirety in FIG. 6 and in an enlarged section of a portion thereof in FIG. 7. With reference to FIG. 6, at the upstream or right end of the apparatus, as illustrated in FIG. 6, the supply rolls 84, 86 and 88 of the materials being laminated, which would be the yarn layer and one or both of the nonwoven layers described above, are positioned in the apparatus so as to be rotatable with appropriate breaking mechanisms to limit the rate of rotation as the continuous sheets or strips of the layers of material are removed from the supply rolls. The sheets or strips of material are supplied to the laminating section of the apparatus over a plurality of idler rollers 92 and fed between two endless transfer belts 94 as possibly seen best in FIG. 7. FIG. 7 illustrates three layers of material, i.e. the yarn layer 28 and both nonwoven layers 22 and 36 being laminated even though as will be appreciated only two of the layers could be laminated as mentioned previously.

As the layers of the laminate are fed between the belts 94 as illustrated in FIG. 7, they are compressed against each other in superimposed relationship and fed downstream as shown in FIG. 6 between two sets of heating chambers 96 and subsequently two sets of cooling chambers 98 with the adhesives being raised above their melting temperatures as the laminate material passes through the sets of heating chambers and cooled to beneath their melting temperatures as it passes through the sets of cooling chambers. As can be appreciated, with the pressure applied to the layers of the laminate between the endless belts 94 and the activation of the glue and subsequent cooling, the layers become adhesively bonded together into a laminate that is wrapped around a take-up roll 100 after passage through a series of tensioning rollers 102 at the downstream end of the apparatus.

The fabric 12 accumulated on the take-up roll can then be used to make a panel 14 for a covering for an architectural opening either in sheet form or folded as desired. When folded and possibly creased in a longitudinal direction, the material which is first cut into strips of a predetermined width can be folded into the cellular structure 16 as shown in FIG. 1. As mentioned previously, once the cells have been formed and adhesively or otherwise secured together, a transversely collapsible panel of covering material is assembled.

As appreciated by reference to FIG. 1, folds 104 and creases 106 can be conventionally placed in the strips of material in order to form the hexagonal cells with the folds and creases all extending in a longitudinal or machine direction of the fabric. The folds and creases are therefore aligned with the length of the yarns 30a and 30b in the yarn layer 28 of the fabric. The fabric 12 is thereby very easily foldable and creasable in that direction but not as easily folded or creased in an orthogonal direction or a direction transverse to the length of the yarns in the yarn layer. The cells 16 are therefore more likely to desirably retain the configuration illustrated in FIG. 1 in the final covering product.

As mentioned previously, the fabric 12 formed in accordance with the present invention, depending upon the nature of the yarns used in the fabric, can assume numerous characteristics relating to opacity, color, tactility, density, aesthetics, and strength. Preferably, naturally occurring yarns are used with synthetic or polymer yarns to obtain both softness and strength in the same product. The color of the yarns can be made as desired with suitable dyes and the opacity varied with the density of the yarns in the fabric. A fabric of the type described has many variable characteristics that can be selected as desired for the varied uses of the fabric in coverings for architectural openings.

Although the present invention has been described with a certain degree of particularity, it is understood the present disclosure has been made by way of example, and changes in detail or structure may be made without departing from the spirit of the invention as defined in the appended claims.

1. A covering for an architectural opening comprised of a fabric laminate of:
a) a layer of nonwoven material adhesively bonded to
b) a layer of side-by-side parallel yarns including polymer yarns and yarns of natural fibers.

2. The covering of claim 1 wherein said layer of yarns has said polymer yarns substantially alternating with said yarns of natural fibers.

3. The covering of claim 1 or 2 wherein said polymer yarns are polyester yarns and said yarns of natural fibers are cotton yarns.

4. A covering for an architectural opening comprised of a fabric laminate of:
a) a layer of nonwoven material adhesively bonded to a first side of
b) a layer of side-by-side parallel yarns including polymer yarns and yarns of natural fibers, and
c) a second layer of nonwoven material adhesively bonded to a second side of said layer of yarns.

5. The covering of claim 4 wherein said layer of yarns has said polymer yarns substantially alternating with said yarns of natural fibers.

6. The covering of claim 4 or 5 wherein said polymer yarns are polyester yarns and said yarns of natural fibers are cotton yarns.

7. The covering of claim 4 wherein there are substantially 72 yarns per inch in said layer of yarns.

8. The covering of claim 4 wherein said first mentioned layer of nonwoven material is a sheet of manufactured batting or webbing of fabric that is held together by thermo-fusion, resin or solvent bonding to provide an interlocking of fibers.

9. The covering of claim 4 or 8 wherein said second layer of nonwoven material is a sheet of manufactured batting or webbing of fabric that is held together by thermo-fusion, resin or solvent bonding to provide an interlocking of fibers.

10. The covering of claim 1 wherein the covering is made by:
a) applying a coating of adhesive to said first-mentioned nonwoven material,
b) applying a coating of adhesive to said layer of yarns,
c) applying a coating of adhesive to said second nonwoven material, and
d) laminating said adhesively coated layers together.

11. The covering of claim 10 wherein said adhesive coatings are hot-melt adhesives.

12. The covering of claim 11 wherein said coatings are applied in a liquid state and immediately cooled to set the adhesive.

13. The covering of claim 10 wherein said laminate is folded along the length of said yarns and formed into elongated cells and further including the step of securing said cells together along their length to form a cellular panel.

14. The covering of claim 13 wherein said cells are transversely collapsible.
